(19) United States
(12) Patent Application Publication
(10) Pub. No.: US 2024/0167252 A1
(43) Pub. Date: May 23, 2024

(54) SYSTEMS AND METHODS FOR AQUIFER REPLENISHMENT, WATER FILTRATION, AND DESALINATION

(71) Applicant: Colton Callison, Topeka, KS (US)

(72) Inventor: Colton Callison, Topeka, KS (US)

(21) Appl. No.: 18/056,330

(22) Filed: Nov. 17, 2022

(51) Int. Cl. E03B 3/06; B01D 24/00; B01D 24/10; B01D 61/02; B01D 61/06; B01D 61/08; C02F 1/00; C02F 1/28; C02F 1/44

(52) U.S. Cl. CPC E03B 3/06; B01D 24/007; B01D 24/10; B01D 61/025; B01D 61/06; B01D 61/08; C02F 1/004; C02F 1/283; C02F 1/441; C02F 2103/08

(57) ABSTRACT

A method for refilling an aquifer includes establishing an air extraction well into the aquifer. The aquifer includes a water table of groundwater. A vacuum pump is coupled in flow communication to the air extraction well. The vacuum pump is then activated to remove air from the aquifer, thereby reducing a subsurface air pressure and facilitating refilling the aquifer with groundwater.

### FIELD OF THE INVENTION

The present invention relates generally to aquifer replenishment and water filtration and, more particularly, to systems and methods for water filtration/desalination and for extracting air from aquifers to facilitate refilling the aquifers.

### BACKGROUND

Groundwater is a common source of fresh water for human consumption, irrigation, and various other uses. Typically, groundwater is contained in aquifers. Aquifers are subterranean formations made up of caves, caverns, and/or layers of permeable material, such as sand and gravel, which channel the flow of groundwater. Generally, groundwater is extracted from aquifers by drilling or boring wells down to the water table.

The replenishment of aquifers is a growing problem. Many aquifers are overused, significantly depleting the supply of groundwater. Typically, aquifers are replenished when rain falls on the land and is absorbed into the soil. However, due to overuse, the groundwater supply often cannot be renewed as rapidly as it is withdrawn.

Moreover, while aquifers provide a freshwater source for human use, the vast majority of water on earth is saltwater. Current methods for desalinating saltwater, however, are energy inefficient. In addition, the high cost of pretreatment and concentrated waste streams typically make current desalination processes uneconomical.

Thus, there is a need for improved systems and methods for water recovery.

### BRIEF DESCRIPTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a method is provided. The method includes establishing an air extraction well into an aquifer. The aquifer includes a water table. The method also includes establishing fluid communication between a vacuum pump and the air extraction well. Furthermore, the method includes extracting air from the aquifer via the vacuum pump.

In another aspect, an underwater water filter system is provided. The underwater water filter system includes a filter lift, a filter line, and a filter box. The filter box is coupled to the filter line and the filter lift. Furthermore, the filter box is configured to be placed under a surface of a body of water. The filter box includes a wall enclosure defining an internal cavity. The wall enclosure includes a bottom side defining a plurality of apertures providing fluid communication between the internal cavity and the body of water, and a filter disposed within the cavity.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The drawing figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIGS. 1-2 are schematics in cross-section of a ground water reservoir or aquifer, in accordance with an aspect of the invention;

FIG. 3 is a schematic in cross-section of the ground water reservoir or aquifer shown in FIGS. 1 and 2, in accordance with another aspect of the invention;

FIG. 4 is a schematic of an air extraction well shown in FIGS. 1 and 2;

FIG. 5 is a schematic in cross-section of an underwater water filter system, in accordance with an aspect of the present invention;

FIG. 6A is a top perspective view of one example embodiment of a filter box for use in the underwater filter system of FIG. 5;

FIG. 6B is a bottom perspective view of the filter box shown in FIG. 6A;

FIG. 7 is a section view of an embodiment of the filter box shown in FIGS. 6A and 6B, in accordance with an aspect of the invention; and

FIG. 8 is a section view of another embodiment of the filter box shown in FIGS. 6A and 6B, in accordance with another aspect of the invention.

Unless otherwise indicated, the drawing figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION

The following detailed description of embodiments of the disclosure references the accompanying drawing figures. The embodiments are intended to describe aspects of the disclosure in sufficient detail to enable those with ordinary skill in the art to practice the disclosure. The embodiments of the disclosure are illustrated by way of example and not by way of limitation. Other embodiments may be utilized, and changes may be made without departing from the scope of the claims. The following description is, therefore, not limiting. The scope of the present disclosure is defined only by the appended claims, along with the full scope of equivalents to which such claims are entitled.

Broadly, aspects of the invention are directed to systems and methods for increasing the replenishment rate of an aquifer. One or more extraction wells are defined in an aquifer. A vacuum pump is coupled in flow communication to the extraction wells to remove subsurface air that is located in the aquifer. Furthermore, aspects of the disclosure include systems and methods for filtering water, whether fresh water or saltwater, using an underwater filter system. A filter box includes downward facing apertures that allow water to be pushed upward therethrough due to forces of the weight of the water above the submerged filter box. In one aspect, the filter box includes a reverse osmosis filter to facilitate desalinating saltwater. Because fresh water is lighter than saltwater, the weight of the saltwater facilitates pushing the freshwater from the filter box to a surface of the body of saltwater.

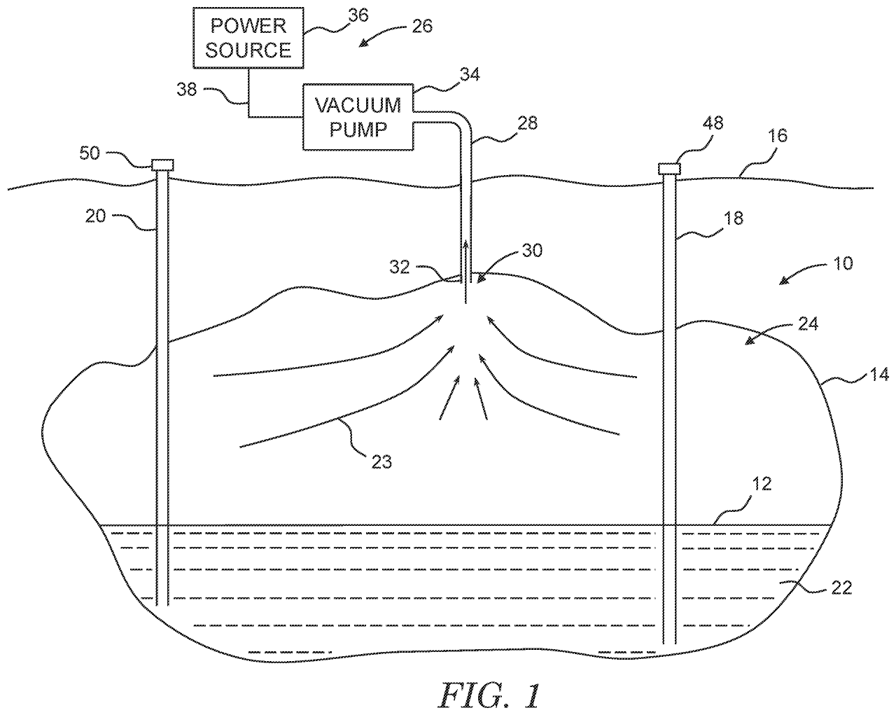

Turning now to the drawing figures, FIGS. 1 and 2 are schematics in cross-section of a ground water reservoir or aquifer 10, in accordance with an aspect of the invention. In the example, the aquifer 10 is a karst type aquifer. A karst type aquifer includes an underground cave or cavern 14 that has a groundwater table 12. The aquifer 10 is located a distance below the ground surface 16. While described herein as being a karst type aquifer, it is contemplated that the aquifer 10 may be any type of aquifer, including, for example, porous, fractured, confined, unconfined, and the like.

In the example embodiment, the aquifer 10 has a plurality of water wells, such as water wells 18 and 20, drilled or otherwise defined therein. The water wells 18 and 20 are cased wells that generally extend deep into or proximate the bottom of the groundwater table 12. Typically, such water wells include a submersible pump (not shown) proximate the bottom of the well to pump groundwater 22 to the ground surface 16 for subsequent use. As the groundwater 22 is withdrawn from the aquifer 10 and pumped to the ground surface 16, an air-filled cavity 24 is defined within the aquifer 10. More particularly, the air-filled cavity 24 is formed in the cave or cavern 14 above the groundwater table 12. Air 23 is introduced into the aquifer 10, for example, via the plurality of water wells, such as water wells 18 and 20, that penetrate the aquifer. As used herein, the term “air” is used broadly and includes any gas or gaseous mixture, such as atmospheric oxygen-containing gases, hydrogen sulfide (H₂S), methane (CH₄), and/or other gases from the local environment, that may infiltrate the aquifer 10.

An embodiment of the present invention also includes at least one air extraction well 26. The air extraction well 26 includes a gas-impermeable conduit 28 along its length. The conduit 28 extends downward from the ground surface 16 to an upper portion 30 of the cave or cavern 14. In particular, a lower end 32 of the conduit 28 is positioned proximate a ceiling of the cave or cavern 14 (i.e., into fluid communication with an internal space of the aquifer). In this manner, the conduit 28 is positioned to facilitate extracting the air 23 from the aquifer 10. The gas-impermeable conduit 28 of the air extraction well 26 may be fabricated from metal or plastic piping, including, for example, PVC, copper, steel, and the like.

The air extraction well 26 also includes one or more vacuum pumps 34 (or other gas extraction devices, such as a fan and the like). In an example embodiment, a capacity of the vacuum pump 34 is determined, for example, based on a geological survey of the aquifer 10, which may determine an inflow/out flow rate of the groundwater 22 and/or the air 23 in relation to the cave or cavern 14. In one or more embodiments, the vacuum pump 34 is configured to draw the air 23 into the conduit 28 in a controlled manner to facilitate refilling of the aquifer 10 with the groundwater 22 (i.e., raising the groundwater table 12 within the cave or cavern 14 a distance H (shown in FIG. 2)). It is noted that subsurface gas pressures, for example from the infiltration of the air 23, may reduce and/or prevent the ability of the aquifer 10 to refill and/or become recharged with the groundwater 22. The vacuum pump 34, therefore, facilitates reducing and/or eliminating such subsurface gas pressures in the aquifer by removing the air 23 therefrom.

In an example, the air extraction well 26 also includes at least one power source 36. The power source 36 generates and/or stores power and provides/transmits power to the vacuum pump 34. In one or more embodiments, the power source 36 may include, for example, one or more of an electric grid (such as a residential power grid), a photovoltaic power source, a wind power source, a thermal power source, and a hydro power source. For example, a photovoltaic power source may include residential scale photovoltaic systems, commercial scale photovoltaic systems, utility scale photovoltaic systems, or combinations thereof. A wind power source may include a windmill coupled directly to the vacuum pump 34 to transmit mechanical power thereto or a wind powered generator coupled in electrical communication to the vacuum pump 34 to transmit electrical power thereto.

In one or more embodiments, the power source 36 is in electric communication with the vacuum pump 34 via a distribution network 38. The distribution network 38 may include, for example, one or more components (not shown) that are used to regulate voltage in the distribution network 38, such as a capacitor bank, an energy storage element, a static synchronous compensator, a voltage regulator, a load tap changer, or combinations thereof.

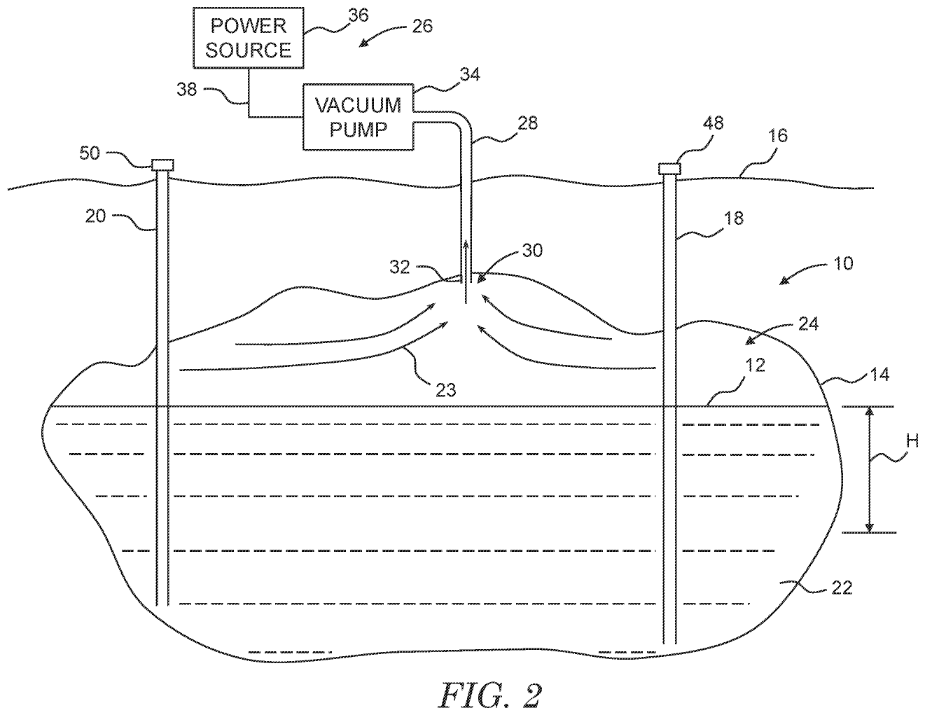

FIG. 3 is a schematic in cross-section of the ground water reservoir or aquifer 10, in accordance with another aspect of the invention. In the depicted embodiment, the aquifer 10 includes an alternative air extraction well 126. The air extraction well 126 includes a plurality of vertical, gas-impermeable conduits 128a, 128b, and 128c, along their lengths. The vertical conduits 128a, 128b, and 128c extend downward from the ground surface 16 to the upper portion 30 of the cave or cavern 14. In particular, lower ends 132a, 132b, and 132c of the vertical conduits 128a, 128b, and 128c, respectively, are positioned proximate the ceiling of the cave or cavern 14 (i.e., into fluid communication with an internal space of the aquifer). In this manner, the vertical conduits 128a, 128b, and 128c are positioned to facilitate extracting the air 23 from the aquifer 10. The vertical conduits 128a, 128b, and 128c are coupled in flow communication to the vacuum pump 34 via a manifold 130.

While the manifold 130 is depicted in FIG. 3 as being above the ground surface 16, it is contemplated that the manifold 130 may be above the ground surface 16, below the ground surface 16, or a combination thereof. The vertical conduits 128a, 128b, and 128c and the manifold 130 of the air extraction well 126 may be fabricated from metal or plastic piping, including, for example, PVC, copper, steel, and the like.

In the illustrated embodiment, the vertical conduits 128a and 128c are formed generally cooperatively with the water wells 18 and 20, respectively. For example, and without limitation, the vertical conduits 128a and 128c may include pipes that are positioned concentrically to, whether within or surrounding, the casings of the water wells 18 and 20. In one example, the water wells 18 and 20 may include casings with perforations or openings within the cave or cavern 14 to draw the groundwater 22 therein. In such an embodiment, the vertical conduits 128a and 128c may be positioned within the casings of the water wells 18 and 20 to utilize the perforations or openings to extract the air 23. Alternatively, the vertical conduits 128a and 128c may be placed into the aquifer 10 first with the casings of the water wells 18 and 20 being positioned within the vertical conduits 128a and 128c.

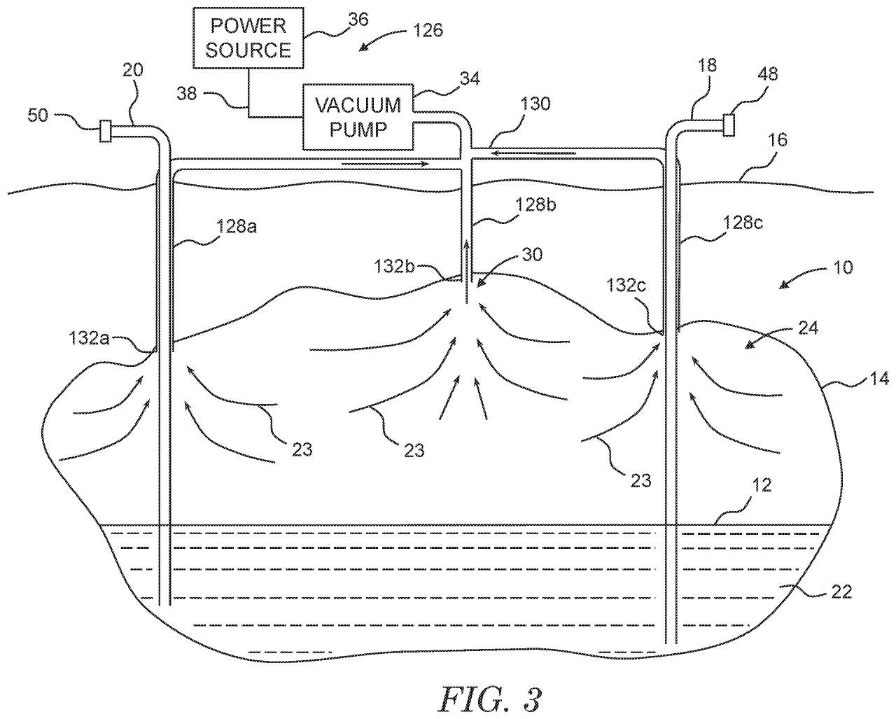

FIG. 4 is a schematic of the air extraction well 26. As described above, the conduit 28 extends downwardly from the vacuum pump 34. A switch assembly 40 is positioned at the lower end of the conduit 28. The switch assembly 40 is configured to switch the vacuum pump 34 on and off, when the switch assembly 40 is activated. As depicted in FIG. 4, the switch assembly 40 is in signal and/or electrical communication with the vacuum pump 34 via one or more signal wires 42. The one or more signal wires 42 are configured to enable the switch assembly 40 to communicate with the vacuum pump 34 for switching the vacuum pump 34 on and/or off. One of ordinary skill will appreciate that a wireless or other signal communication system may replace signal wires without departing from the spirit of the present invention. It is noted that, in one or more embodiments, activating the switch assembly 40 includes energizing or de-energizing an electrical circuit of the vacuum pump 34 thereof without departing from the spirit of the present invention, and likewise for deactivating the switch assembly 40.

In one example, the switch assembly 40 includes a pressure sensitive actuator. As the air 23 is removed from the aquifer 10, the groundwater 22 rises. As the groundwater 22 rises above the bottom of the pressure sensitive actuator, there is an increase in the pressure of the air trapped in a portion of the pressure sensitive actuator. When the air pressure increases a predetermined amount, the pressure sensitive actuator switches the vacuum pump 34 off. When the groundwater 22 drops below the pressure sensitive actuator, the air pressure in the pressure sensitive actuator drops, and the pressure sensitive actuator switches the vacuum pump 34 on.

In another embodiment, the switch assembly 40 is a float switch. The float switch includes a float (not shown) that incorporates an electrical switch (not shown). As the groundwater 22 rises above the bottom of the float, the float begins to rise with the groundwater 22. When the float rises a predetermined amount, the float actuates the electrical switch to switch the vacuum pump 34 off. When the groundwater 22 drops, the float drops. After the float drops a predetermined amount, the float actuates the electrical switch to switch the vacuum pump 34 on.

In operation, to increase the refill rate of an aquifer, such as the aquifer 10, the following method may be employed. At least one air extraction well, such as the air extraction well 26 (shown in FIGS. 1 and 2), is established in an aquifer, such as the aquifer 10 (shown in FIGS. 1 and 2). More particularly, a borehole with a vertical component (e.g., a vertical or substantially vertical borehole) is created in the ground surface 16 above the aquifer 10. The vertical borehole is extended downward into the ground to a point underground where the borehole connects in fluid communication with an internal space (e.g., an upper portion (or ceiling)) of an aquifer capable of providing groundwater and/or having a water table defined therein. In the example embodiment, the vertical borehole is drilled or otherwise bored into an underground cave or cavern, such as the cave or cavern 14 (shown in FIGS. 1 and 2), of a karst type aquifer. As the vertical borehole is created, a pipe, such as the gas-impermeable conduit 28 (shown in FIGS. 1 and 2), is inserted into the wellbore such that a lower end of the pipe is positioned proximate the ceiling of the cave or cavern (i.e., into fluid communication with an internal space of the aquifer).

In one or more embodiments, a plurality of pipes, such as vertical conduits 128a, 128b, and 128c (shown in FIG. 3), may be established in and/or for fluid or flow communication with the aquifer 10 in a manner substantially as described above for the gas-impermeable conduit 28. These vertical conduits 128a, 128b, and 128c may be individual conduits and/or conduits defined coincident with an existing wellbore or water well. The pipes are coupled to a manifold, such as the manifold 130. The manifold 130 is coupled to the vacuum pump 34. As such, the vacuum pump 34 may extract the air 23 from the aquifer via a plurality of pipes.

A vacuum pump, such as the vacuum pump 34 (shown in FIGS. 1 and 2), is coupled in fluid or flow communication with the pipe, such as the gas-impermeable conduit 28 (shown in FIGS. 1 and 2), to facilitate extraction of air from the aquifer. A switch assembly, such as the switch assembly 40 (shown in FIG. 4), is positioned at the bottom of the pipe. The switch assembly is electrically coupled to the vacuum pump to facilitate switching the vacuum pump on (i.e., its operating state) and off (i.e., its resting state).

A power source is coupled to the vacuum pump to facilitate powering the vacuum pump. In one or more embodiments, the power source is an electrical power source coupled in electrical communication to the vacuum pump to supply electrical power thereto. The power source may be in electrical communication with or coupled to the vacuum pump via a power distribution network, such as the power grid or a local power network connection. In another embodiment, the power source is a mechanical power source coupled directly to the vacuum pump to supply mechanical power thereto. For example, in one or more embodiments, the mechanical power source may include a windmill that provides mechanical power to the vacuum pump via wind turning the windmill.

The method also includes capping any open wellbores (or wells) that are located or otherwise penetrate or are defined in the aquifer. For example, in some embodiments, an aquifer many include many water wells, wellbores, etc. that were created to draw groundwater from the aquifer. Some of the water wells may be operational and, as such, generally sealed at the ground surface to reduce or prevent infiltration of air into the aquifer. Others of the wells or wellbores, however, may be open to the atmosphere, thereby allowing air to freely infiltrate the aquifer. As such, to facilitate extracting air from the aquifer via the air extraction well 26, all ground surface air infiltration points (e.g., aboveground wellbore openings) should be capped or otherwise sealed. Capping and/or sealing ground surface air infiltration points increases the efficiency of the air extraction well 26. Referring back to FIGS. 1 and 2, each of the water wells 18 and 20 includes a cap and/or seal 48 and 50, respectively, to prevent atmospheric air from infiltrating the aquifer 10.

The method also includes extracting air, such as the air 23, from the aquifer. In particular, the vacuum pump 34 is operated to induce an air vacuum in the underground cave or cavern 14 of the aquifer and, more particularly, in the air-filled cavity 24 formed in the cave or cavern 14 above the groundwater table 12. This facilitates removing the air 23 from the air-filled cavity 24, thereby enabling the water table 12 to rise.

The method also includes switching the vacuum pump off when the water table 12 rises to the level of the bottom of one or more of the pipe(s) (e.g., the gas-impermeable conduit 28) of the vacuum pump 34. As described above, the vacuum pump includes a switch assembly positioned at the bottom of the pipe that is activated by the rising water table 12. One of ordinary skill will, however, appreciate that the switch assembly and/or its actuator may be positioned elsewhere and/or that switching off the vacuum pump may correspond to a different actuating event and/or water level within the scope of the present invention.

The method also includes switching the vacuum pump on when the water table 12 falls below the level of the bottom of the pipe (e.g., the gas-impermeable conduit 28) of the vacuum pump 34 or another level detectable by the system. For example, the switch assembly is switched (or actuated) by the lowering or falling water table 12.

The embodiments described above with respect to FIGS. 1-4 provide systems and methods for extracting excess air from an aquifer to facilitate increasing the refill rate of the aquifer. Extracting the excess air or other gases lowers gas pressure within the aquifer to allow the groundwater to fill the aquifer more easily with lessened need to overcome subsurface air or gas pressure.

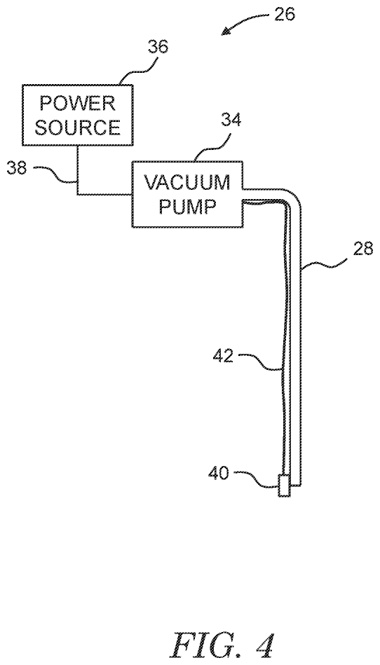

FIG. 5 is a schematic in cross-section of an underwater water filter system 200, in accordance with one aspect of the present invention. The underwater water filter system 200 includes a filter box 202 configured to be placed under a surface 204 of a body of water 206. In the example embodiment, the body of water 206 comprises saltwater 208, such as found in an ocean or sea. The filter box 202 is configured to filter the saltwater 208 to remove the salt therefrom (e.g., desalinate the saltwater 208). It is contemplated, however, that the filter box 202 may be used in any type of water, such as fresh water in a lake, river, etc.

In the example embodiment, the underwater water filter system 200 also includes a filter lift 210. The filter lift 210 may be any type of lift/suspension system configured to lift/lower and suspend the filter box 202 within the body of water 206. For example, and without limitation, the filter lift 210 may include a crane or hoist (not shown) arranged on a floating facility (e.g., a boat, ship, barge, etc.) located on the surface 204 of the body of water 206.

The filter box 202 is attached to the filter lift 210 via a lift line 212. In an example, the lift line 212 includes a cable or chain configured to support and lift the filter box 202. Furthermore, in some embodiments, the lift line 212 may also include a hollow flexible tube to inject and/or remove air from the filter box 202. For example, the filter box 202 may contain an amount of air therein before being placed in the body of water 206. As the filter box 202 is lowered beneath the surface 204 of a body of water 206, the air may remain trapped therein. Like the aquifer 10 describe above with respect to FIGS. 1-4, the trapped air prevents the filter box from filling with water, such as the saltwater 208. The air may be extracted from the filter box 202 via the lift line 212 (i.e., the hollow flexible tube), to enable the water to fill the filter box 202, as further described below.

The underwater water filter system 200 also includes a fluid line 214 coupled in flow communication to the filter box 202 and to a water treatment/pumping facility 216. The fluid line 214 is configured to channel filtered water from the filter box 202 to the water treatment/pumping facility 216, for further distribution therefrom. In the example embodiment, the filter line 214 is a hollow flexible line sized to accommodate a predetermined water flow rate associated with the filter box 202. That is, the filter box 202 is configured to filter a predetermined amount of water over a determined period, and the filter line 214 is configured to channel that approximate amount of the filtered water to the water treatment/pumping facility 216. In the example embodiment, the filter line 214 is fabricated from a flexible material, such as PVC, polyurethane, rubber, or the like. The filter line 214 may be fabricated from a single material or two or more materials (e.g., fiber reinforced tubing, jacketed tubing, stainless steel braided tubing, etc.).

Optionally, the underwater water filter system 200 may include one or more water turbine/electric generator components 218 along filter line 214, for example interposed between and in fluid communication respectively with the filter box 202 and the water treatment pumping facility 216. The filtered water flowing through the filter line 214 provides a force to operate the water turbine/electric generator component(s) 218. Electrical power generated by the water turbine/electric generator components 218 may be transmitted to the water treatment/pumping facility 216 for use therein and/or to an electric grid (not shown) for further distribution. The water turbine/electric generator components 218 facilitate(s) extracting energy from the flowing water to increase efficiency of the underwater water filter system 200.

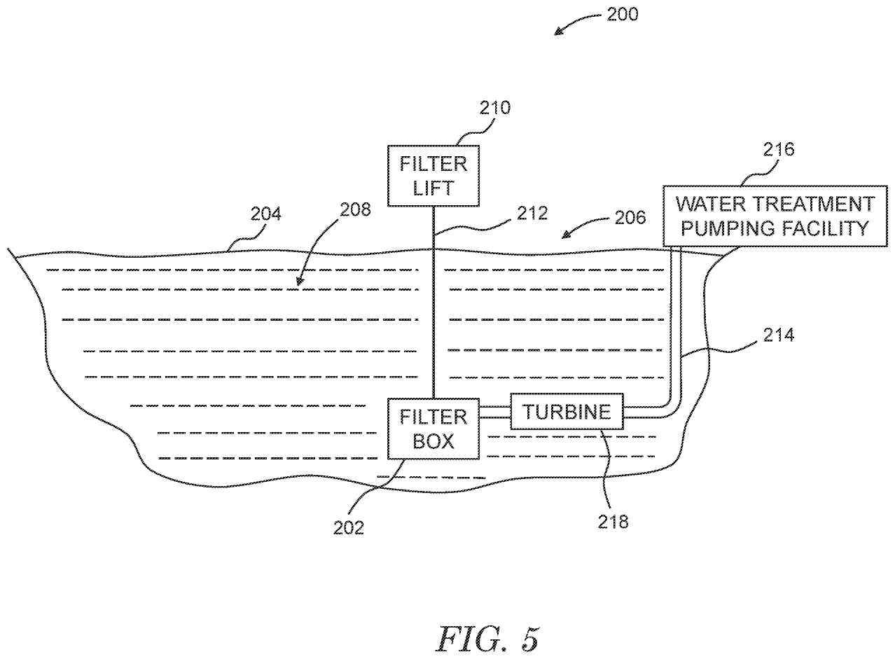

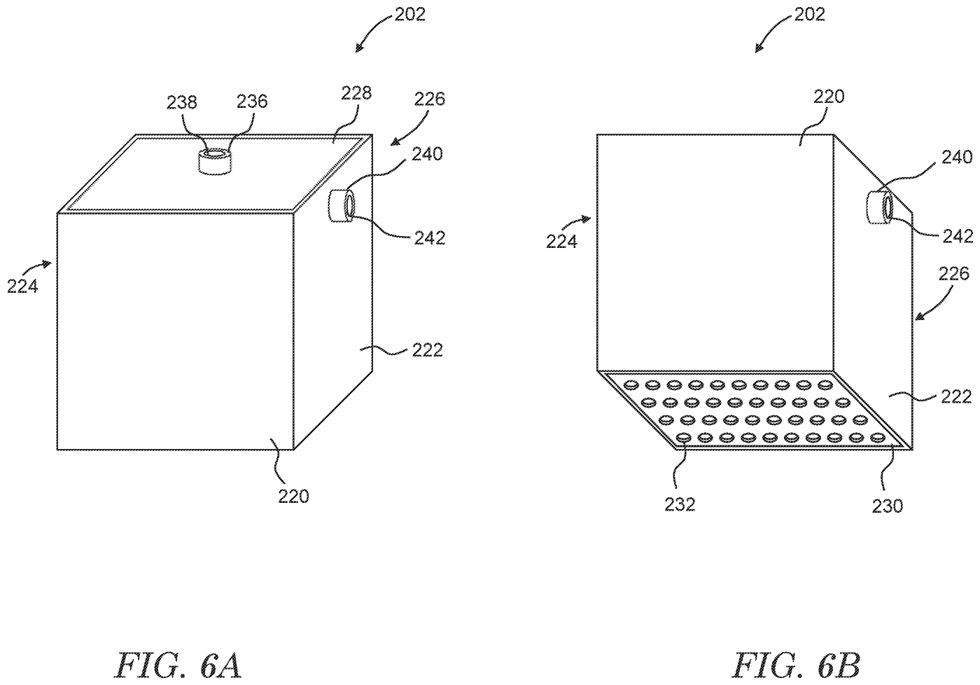

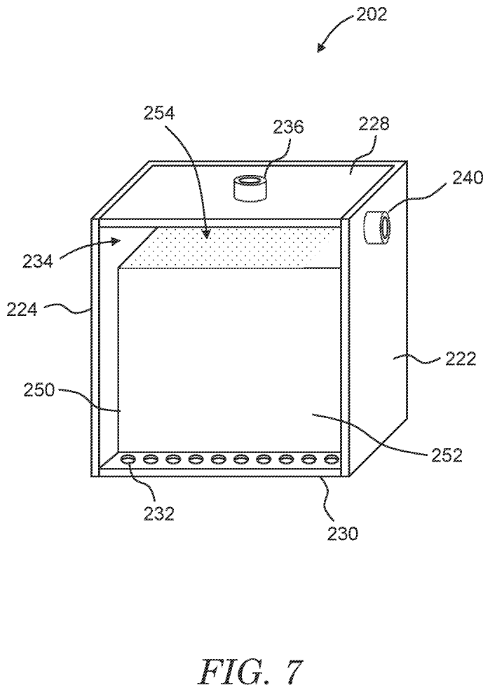

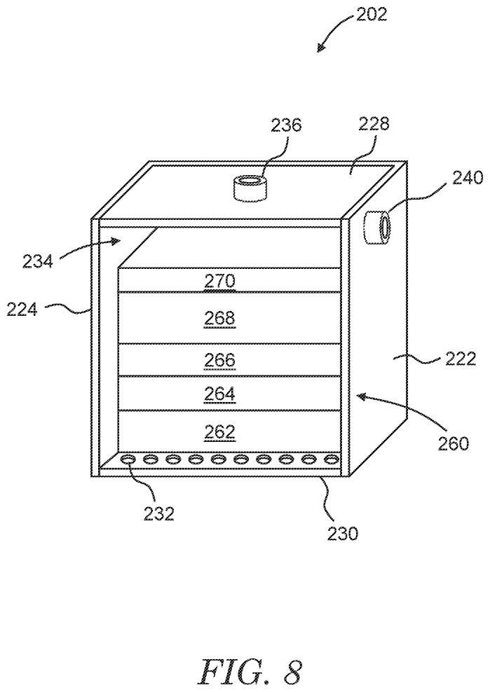

FIG. 6A is a top perspective view of one example embodiment of the filter box 202, according to an aspect of the present invention. FIG. 6B is a bottom perspective view of the example embodiment of the filter box 202. In the exemplary embodiment, the filter box 202 includes a front wall 220, an opposite back wall 226, a first sidewall 222, and an opposite second sidewall 224. Furthermore, the filter box 202 includes a top wall 228 and a bottom wall 230. In the example, at least one of the top wall 228 and the bottom wall 230 is removeable to facilitate access to a cavity 234 (see FIGS. 7 and 8) defined therein. The front wall 220, opposite back wall 226, first sidewall 222, opposite second sidewall 224, top wall 228, and bottom wall 230 are coupled together to form a wall enclosure that defines the cavity 234.

The exemplary filter box 202 is a fabricated container that is substantially cuboid in shape. The filter box 202 is fabricated from a material suitable for long exposure to water, such as the saltwater 208 (shown in FIG. 5). For example, and without limitation, the filter box 202 may be fabricated from a stainless steel, a synthetic resin, fiber reinforced resins (e.g., fiberglass, etc.), or the like. The example filter box 202 is fabricated from a stainless steel and has one or more watertight seams defined between the front wall 220, opposite back wall 226, first sidewall 222, and/or the opposite second sidewall 224. The one or more seams may be welded to form watertight seams (i.e., a watertight sidewall).

As used herein, the term “watertight” refers to the ability of the named structure to, when submerged, either prevent the ingress of water (through penetration of the structure) at a pressure corresponding to the intended operating depth of the structure and/or to satisfy the criteria of Ingress Protection (IP) rating 68 propagated by the International Electrotechnical Commission (IEC) under the designation 60529 (that is, IEC 60529) as of the date of the initial filing of the present disclosure.

Accordingly, a watertight sidewall prevents water penetration therethrough (i.e., through the wall or its adjacent seams) sufficient to be labeled “watertight” even where another associated wall (e.g., the bottom wall 230) permits ingress via water penetration therethrough (e.g., through apertures defined in the bottom wall 230) and into a cavity defined by the watertight sidewall. (Of course, a watertight filter box would satisfy such criteria generally and prevent the ingress of water into the cavity accordingly.) Similarly, where a sidewall is described as being watertight other than with respect to an aperture or the like, it should be understood that the aperture is the only portion of the described sidewall and its adjacent seams that does not meet the ingress criteria outlined here.

As discussed above, one or more of the top wall 228 and the bottom wall 230 is removeable and may be attached to the welded sidewalls via a watertight seal. In addition, one or the other of the top wall 228 and the bottom wall 230 may be welded to the welded sidewalls. As such, the filter box 202 defines a cuboid-shaped container with at least one access and a plurality of watertight seams. It is contemplated, however, that the filter box 202 may have a different shape, such as, rectangular, cylindrical, ovoid, etc., without departing from the spirit of the present invention. Furthermore, in some aspects of the present invention, two or more of the plurality of walls of the filter box 202 may comprise a monolithic or single piece wall and/or may be multiple pieces fit together without departing from the spirit of the present invention.

As depicted in FIG. 6B, the bottom wall 230 includes a grid or plurality of regularly spaced apertures 232. In the example, the apertures 232 are substantially the same size and are circular in shape. It is contemplated, however, that the apertures 232 may be any shape and sized differently. For example, the apertures 232 may be polygonal, be defined as a plurality of slots, include different shapes and sizes, etc. The apertures 232 are configured to enable one or more stream(s) of water, such as the saltwater 208, to enter the cavity 234 of the filter box 202 through the bottom wall 230.

As depicted in FIG. 6A, the top wall 228 includes a first connector 236 configured to attach to the lift line 212 (shown in FIG. 5). The first connector 236 may be any type of connector that facilitates secure attachment to the lift line 212, such as an eye ring, threaded connection, etc. In one or more embodiments, the first connector 236 may include an aperture 238 that extends to the cavity 234 of the filter box 202. The aperture 238 facilitates a fluid connection between the cavity 234 and the lift line 212 in embodiments where the lift line 212 includes a hollow flexible tube to inject and/or remove air from the filter box 202, as discussed above.

The first sidewall 222 includes a second connector 240 (also referred to as a filter line connector) configured to attach to the filter line 214 (shown in FIG. 5). The second connector 240 may be any type of watertight connector that facilitates secure attachment to the filter line 214, such as a threaded connection, a quick release connection, etc. In the example, the second connector 240 is positioned proximate the top wall 228 and in communication with the cavity 234. In one or more embodiments, the second connector 240 may include an aperture 242 that extends to the cavity 234 of the filter box 202. The aperture 242 facilitates a fluid connection between the cavity 234 and the filter line 214 for flow of fluid (e.g., desalinated water) out of the filter box 202.

FIG. 7 is a section view of an embodiment of the filter box 202, in accordance with an aspect of the invention. In the depicted example, the filter box 202 includes a filter 250 therein. In the example embodiment, the filter 250 is a reverse-osmosis (RO) filter. The RO filter 250 may be constructed using known reverse-osmosis filtering materials. For example, the RO filter 250 may include a layered thin film membrane structure 252 having a plurality of small microspores 254 that allow only small pure water molecules to pass or filter upward through to the cavity 234 of the filter box 202. In some embodiments, the membrane structure 252 may include a separator grid (not shown) formed by a porous material between two or more layers of a reverse-osmosis semipermeable membrane (not shown), with the separator grid being configured to enable water that cannot pass through the reverse-osmosis semipermeable membrane to circulate back to the bottom wall 230. This facilitates allowing unfiltered water to wash away any contaminants that may accumulate on the reverse-osmosis semipermeable membrane layers.

In operation, the filter box 202 is lowered below the surface 204 of the body of water 206 to a predetermined depth, via the filter lift 210 and filter line 212. In one or more embodiments, air or other gas(es) is evacuated from the cavity 234 via the filter line 212. The saltwater 208 passes through the apertures 232, through the membrane structure 252 toward the cavity 234, whereby pure or filtered water enters the cavity 234. Simultaneously, a portion of the saltwater 208 flowing through the apertures 232, along with contaminants, are unable to pass through the membrane structure 252 and therefore flows along the separator grids and downwardly through one or more of the apertures 232. Pressure of the saltwater 208, due to the depth of the filter box 202, forces the saltwater 208 upward through the RO filter 250 at a sufficient flow rate that enables unfiltered saltwater 208 to carry the contaminants left behind back toward the bottom of the filter box 202, and purified water into the cavity 234.

In one or more embodiments, the pressure of the saltwater 208 is sufficient to force air contained in the filter box 202 outward via the filter line 214. Because purified (or fresh) water is lighter than the saltwater 208, the purified water will rise and be forced out of the cavity 234 and into the filter line 214. In one or more embodiments, the pressure of the saltwater 208 is sufficient to force the purified water to the surface 204 of the body of water 206, where the water treatment/pumping facility 216 may then pump the filtered water for distribution. Alternatively, or in addition, in one or more embodiments, the water treatment/pumping facility 216 may include one or more pumps (not shown) to draw the saltwater 208 through the RO filter 250 and the filtered water through the filter line 214 and to the to the surface 204 of the body of water 206. For example, the water treatment/pumping facility 216 may include a vacuum pump (not shown) to provide suction to the filter line 214 and filter box 202 to withdraw air therefrom, and a liquid pump to subsequently pump the filtered water from the water treatment/pumping facility 216. It is noted that the relative size of the filter box 202 and the RO filter 250 may be adjusted to satisfy a particular requirement. In addition, or alternatively, air may be removed from the filter box via the lift line 212. After the air is removed, the saltwater 208 will flow through the filter box 202 via the pressure of the saltwater 208 and/or suction provided by the water treatment/pumping facility 216.

FIG. 8 is a section view of another embodiment of the filter box 202, in accordance with another aspect of the invention. In the depicted example, the filter box 202 includes a layer filter system 260 therein. In the example embodiment, the filter system 260 functions as an earth analog. More particularly, the filter system 260 may include, in serial arrangement upward from the bottom wall 230, a first layer of larger fractured rock 262, a second layer of smaller fractured rock 264, a third layer comprising gravel 266, a fourth layer comprising sand 268, and a fifth level comprising a carbon-based material 270, such as activated carbon, charcoal, and the like. In the example embodiment, the filter system 260 filters the saltwater 208 (when placed in a saltwater body) or fresh water (when placed in a freshwater body) in substantially the same manner as earth layers filter groundwater. The embodiment depicted in FIG. 8 functions substantially the same as described above with respect to FIG. 7.

Embodiments of the underwater water filter system 200 provide an underwater filter box that includes a filter system to remove contaminants from water, such as saltwater. The filter system is placed within a body of water at a predetermined depth, wherein a pressure of the surrounding water forces a portion of the water upward through the filter box. Purified water may then be channeled to a surface of the body of water for subsequent use and/or distribution.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one or more embodiments may also be included in other embodiments but is not necessarily included. Thus, the current technology can include a variety of combinations and/or integrations of the embodiments described herein.

In the specification and claims, reference will be made to several terms, which shall be defined to have the following meanings. The singular forms “a,” “an,” and “the” include plural references unless the context clearly dictates otherwise. “Optional” or “optionally” means that the subsequently described event or circumstance may or may not occur, and that the description includes instances where the event occurs and instances where it does not.

Approximating language, as used herein throughout the specification and the claim, may be applied to modify any quantitative representation that could permissibly vary without resulting in a change in the basic function to which it is related. Accordingly, a value modified by a term or terms, such as “about,” “approximately,” and “substantially” are not to be limited to the precise value specified. In at least some instances, the approximating language may correspond to the precision of an instrument for measuring the value. Here and throughout the specification and claim, range limitations may be combined and/or interchanged. Such ranges are identified and include all the sub-ranges contained therein unless context or language indicates otherwise.

As used herein, directional references, such as, “top,” “bottom,” “front,” “back,” “side,” and similar terms are used herein solely for convenience and should be understood only in relation to each other. For example, a component might in practice be oriented such that faces referred to herein as “top” and “bottom” are in practice sideways, angled, inverted, etc. relative to the chosen frame of reference.

As used herein, the terms “first,” “second,” and “third” may be used interchangeably to distinguish one component from another and are not intended to signify location or importance of the individual components, unless indicated otherwise.

The terms “upward,” “upstream,” “downward,” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The terms “communicate,” “communicating,” “communicative,” and the like refer to both direct communication as well as indirect communication such as through a memory system or another intermediary system.

Although the present application sets forth a detailed description of numerous different embodiments, it should be understood that the legal scope of the description is defined by the words of the claims and equivalent language. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. A method comprising:
establishing an air extraction well into an aquifer, the aquifer including a water table;
establishing fluid communication between a vacuum pump and the air extraction well; and
extracting air from the aquifer via the vacuum pump.

2. The method in accordance with claim 1, wherein establishing the air extraction well comprises:
creating a first borehole in a ground surface above the aquifer, the first borehole extending downward into an upper portion of the aquifer;
inserting a first gas-impermeable conduit into the first borehole; and
positioning a lower end of the first gas-impermeable conduit into fluid communication with an internal space of the aquifer.

3. The method in accordance with claim 2,
creating a second borehole in the ground surface above the aquifer, the second borehole extending downward into the upper portion of the aquifer;
inserting a second gas-impermeable conduit into the second borehole;
positioning a lower end of the second gas-impermeable conduit into fluid communication with the internal space of the aquifer; and
coupling the first and second gas-impermeable conduits to a manifold,
wherein establishing fluid communication between the vacuum pump and the air extraction well comprises coupling the manifold to the vacuum pump.

4. The method in accordance with claim 2,
positioning a second gas-impermeable conduit into the aquifer, wherein the second gas-impermeable conduit is positioned concentrically with one of the one or more open wellbores;
positioning a lower end of the second gas-impermeable conduit into fluid communication with the internal space of the aquifer; and
coupling the first and second gas-impermeable conduits to a manifold,
wherein establishing fluid communication between the vacuum pump and the air extraction well comprises coupling the manifold to the vacuum pump.

5. The method in accordance with claim 2, further comprising:
positioning a switch assembly at the lower end of the first gas-impermeable conduit; and
establishing signal communication between the switch assembly and the vacuum pump,
wherein activation of the switch assembly switches the vacuum pump between its operating state and its resting state.

6. The method in accordance with claim 5, wherein the switch assembly comprises one of a pressure sensitive actuator and a float switch.

7. The method in accordance with claim 5, further comprising:
switching the vacuum pump off when the water table rises and activates the switch assembly.

8. The method in accordance with claim 5, further comprising:
switching the vacuum pump on when the water table falls below the lower end of the first gas-impermeable conduit, thereby deactivating the switch assembly.

9. The method in accordance with claim 1,
the aquifer including one or more open wellbores penetrating into the aquifer,
said method further comprising capping the one or more open wellbores.

10. The method in accordance with claim 1, further comprising:
coupling a power source to the vacuum pump.

11. The method in accordance with claim 10, wherein the power source comprises one or more of the following: an electric grid, a photovoltaic power source, a wind power source, a thermal power source, a hydro power source, and a combination thereof.

12. An underwater water filter system comprising:
a filter lift;
a filter line attached to the filter lift; and
a filter box coupled to the filter line, the filter box being configured to be placed under a surface of a body of water,
said filter box including—
a wall enclosure defining an internal cavity, the wall enclosure including a bottom side defining a plurality of apertures providing fluid communication between the internal cavity and the body of water, and
a filter disposed within the cavity.

13. The underwater water filter system in accordance with claim 12,
said wall enclosure including a top wall,
said top wall comprising a lift line connector,
said lift line connector defining an aperture extending through the lift line connector and the top wall in fluid communication with the cavity,
said underwater water filter system further comprising a lift line coupled to the lift line connector and the filter lift,
said lift line comprising a cable or chain and a hollow flexible tube,
said hollow flexible tube configured to channel air into and out of the cavity.

14. The underwater water filter system in accordance with claim 12,
said wall enclosure comprising a sidewall, a top wall, and a filter line connector,
said filter line connector attached to the sidewall and positioned proximate the top wall,
said filter line connector defining an aperture extending through the filter line connector and the watertight sidewall in fluid communication with the cavity,
said filter line comprising a hollow flexible line configured to channel filtered water out of the cavity.

15. The underwater water filter system in accordance with claim 12, further comprising:
a water treatment/pumping facility,
said filter line being in fluid communication to the cavity of the filter box and the water treatment/pumping facility.

16. The underwater water filter system in accordance with claim 12, further comprising:
a water turbine/electric generator component in flow communication with the filter line.

17. The underwater water filter system in accordance with claim 12,
said filter comprising a reverse-osmosis filter.

18. The underwater water filter system in accordance with claim 17,
said reverse-osmosis filter comprising one or more thin film membrane structures comprising a plurality of small microspores that allow only pure water molecules to pass through to the cavity.

19. The underwater water filter system in accordance with claim 12,
said filter comprising a layer filter system,
said layer filter system comprising, in serial arrangement upward from the bottom wall:
a first layer comprising fractured rock;
a second layer comprising fractured rock smaller in size than the fractured rock of the first layer;
a third layer comprising gravel;
a fourth layer comprising sand; and
a fifth level comprising a carbon-based material.

20. The underwater water filter system in accordance with claim 19, wherein the carbon-based material comprises one of activated carbon and charcoal.
